(19) United States
(12) Patent Application Publication
(10) Pub. No.: US 2005/0205746 A1
(43) Pub. Date: Sep. 22, 2005

(54) Locking device of seat rail for vehicle

(76) Inventors: Jae-Chul Jung, Ulsan-Shi (KR); Masao Nihei, Gyungju-Shi (KR)

Correspondence Address: DLA PIPER RUDNICK GRAY CARY US LLP, P. O. BOX 9271, RESTON, VA, 20195, US

(21) Appl. No.: 11/004,271

(22) Filed: Dec. 3, 2004

(30) Foreign Application Priority Data
Feb. 23, 2004 (KR) 10-2004-11859

(51) Int. Cl. F16M 13/00

(52) U.S. Cl. 248/429

(57) ABSTRACT

A locking device of a seat rail for a vehicle, designed to solve problems, such as clearance or engagement error occurring in a conventional single lock member. The locking device comprises a lower rail, an upper rail coupled to the lower rail, a locking guide fixed to a bottom surface of the upper rail, a pair of lock members lifted and lowered inside the locking guide and having a plurality of locking protrusions, a plurality of locking grooves formed through a bottom surface of the lower rail so as to be engaged with the locking protrusions, and a lock spring inside the locking guide to constantly press the lock members such that the locking protrusions are engaged with the locking grooves. Even when deformation occurs on the seat rail, since all or some of the plurality of locking protrusions can be maintained in an engaged stated with the locking grooves in a manner that the locking protrusions are alternately disposed on the seat rail, engagement between the locking protrusions and the locking grooves can be safely maintained.

### BACKGROUND OF THE INVENTION

1. Field of the Invention

The present invention relates to a locking device of a seat rail for a vehicle, and more particularly, to a locking device of a seat rail for a vehicle, designed to enable forward and backward movements of lower and upper rails constituting the seat rail to be controlled, thereby allowing passengers to maintain an optimal state on the vehicle seat.

2. Description of the Related Art

Vehicle seats serve to maintain the posture of a passenger in a vehicle, and are fixed at an upper portion of a seat rail, which allows the vehicle seat to slide linearly thereon according to physical features of the passenger, so that the passenger can maintain a comfortable posture on the seat.

Referring to FIG. 8, a seat rail 1 generally includes a lower rail 2 fixed to a vehicle body, and an upper rail 3 coupled to the lower rail 2 and having a seat for a passenger fixed thereon.

The seat rail 1 is provided with a locking guide 6, which is fixed to the bottom surface of the upper rail 3 and has guide holes 5 formed through the bottom surface of the locking guide 6 so as to allow components of a lock member 10 to enter or exit therethrough. The seat rail 1 further includes the lock member 10, which is disposed between the upper rail 3 and the locking guide 6. The lock member 10 is connected at an upper portion to an operating lever, and has a plurality of locking protrusions 7 and 8 formed at a lower portion, so that the lock member 38 can be lifted and lowered inside the locking guide 6.

The lower rail 2 has locking grooves 11 and 12 uniformly spaced in the longitudinal direction at the center of the lower rail 2, such that the locking protrusions 7 and 8 can be engaged with the locking grooves 11 and 12. Moreover, the lock member 10 is installed with a lock spring 15, which constantly presses the lock member 10 so as to force the locking protrusions 7 and 8 to be engaged with the locking grooves 11 and 12, thereby completing a locking device 15.

According to the conventional locking device 15 described above, as shown in FIG. 9, when the locking protrusions 7 and 8 of the lock member 10 are initially engaged with the locking grooves 11 and 12, serious problems do not occur except for minute gaps G defined between the locking protrusions 7 and 8 and the locking grooves 11 and 12.

However, when the seat rail is repositioned, the right and left sides of the seat rail are not accurately aligned, so that the locking protrusions 7 and 8 and the locking grooves 11 and 12 of the locking member provided to the right and left sides of the seat rail are not accurately engaged with each other.

That is, even though the locking protrusion 7 or 8 and the locking groove 11 or 12 at one side of the seat rail are accurately engaged, the locking protrusion 7 or 8 is incompletely matched to the locking groove 11 or 12 at the other side due to twisting of the seat rail and the like, and is thus not engaged with the locking groove 11 or 12, causing non-engagement or incomplete engagement between the locking protrusions and the locking grooves.

In this case, sufficient rigidity cannot be maintained in the seat rail, and thus, when external force is applied to the seat by virtue of collision and the like, the seat rail cannot overcome such external force, causing injury to the passenger.

In particular, when the locking protrusions 7 and 8 are engaged with the locking grooves 11 and 12, intimate contact between the locking protrusions and the locking grooves cannot be ensured due to deformation of related components during the use of the vehicle seat. As a result, the locking protrusions contact one side of the locking grooves or are positioned at the center of the locking grooves without contacting the locking grooves, thereby further reducing the rigidity (safety) of the seat rail.

Additionally, when clearance is created due to tolerance or abrasion of connected portions between associated components of the seat rail, such as the lever to activate the lock member and the like, it can cause problems, such as incomplete engagement between the locking protrusions and the locking grooves.

### SUMMARY OF THE INVENTION

The present invention has been made to solve the above problems, such as clearance or engagement error caused by a conventional single lock member, and it is an object of the present invention to provide a locking device, designed to maintain a locked state of components of the locking device by use of a pair of lock members even when the left and right sides of the seat rail are not located at the same position and then deviated from their regular positions due to twisting or deformation of the seat rail, thereby ensuring vehicle seat safety while enhancing comfort of the vehicle seat.

### BRIEF DESCRIPTION OF THE DRAWINGS

The foregoing and other objects and features of the present invention will be more clearly understood from the following detailed description taken in conjunction with the accompanying drawings, in which:

FIG. 1 is an exploded perspective view illustrating a seat rail for a vehicle with a locking device in accordance with one embodiment of the present invention;

FIG. 2 is a cross-sectional view illustrating the locking device taken along the line A-A of FIG. 1;

FIG. 3 is a cross-sectional view illustrating the locking device taken along the line B-B of FIG. 1;

FIG. 4 is a view illustrating the locking device of the seat rail for the vehicle in a locked state in accordance with one embodiment of the present invention;

FIG. 5 is an enlarged cross-sectional view illustrating the locking device of the seat rail for the vehicle in the locked state in accordance with one embodiment of the present invention;

FIG. 6 is a perspective view illustrating a seat rail for a vehicle with a locking device in accordance with another embodiment of the present invention;

FIG. 7 is a perspective view illustrating a seat rail for a vehicle with a locking device in accordance with yet another embodiment of the present invention;

FIG. 8 is a cross sectional view illustrating a conventional locking device of a seat rail for a vehicle, in which some components of the locking device are omitted for clarity; and

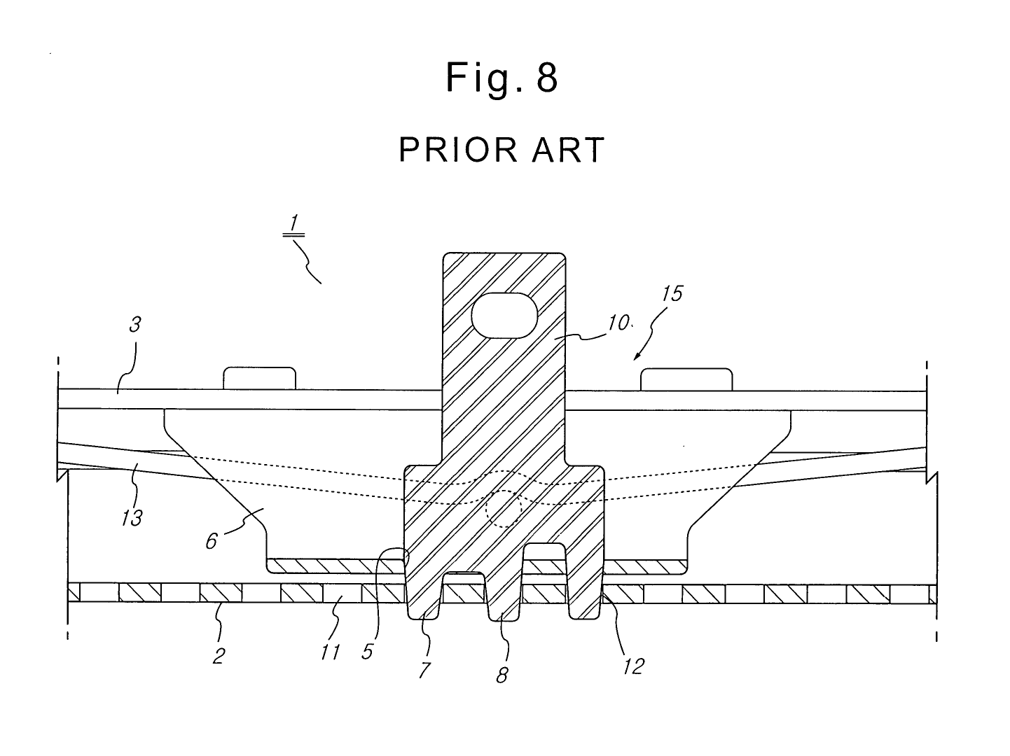

FIG. 9 is an enlarged cross-sectional view illustrating a locked portion of the conventional locking device of the seat rail for the vehicle.

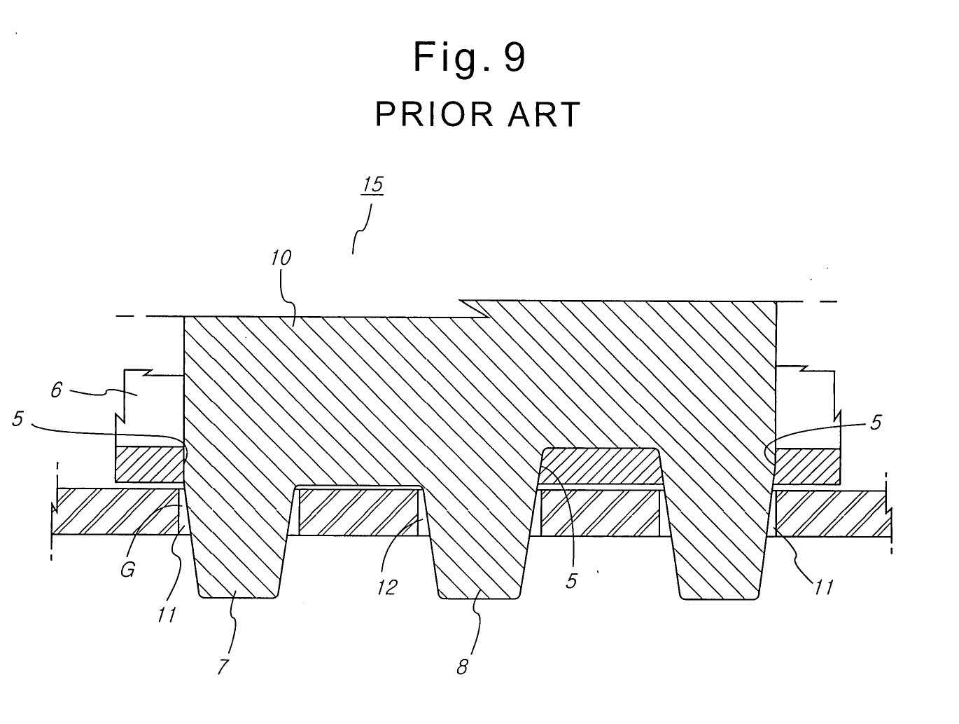

### DESCRIPTION OF THE PREFERRED EMBODIMENTS

Preferred embodiments will now be described in detail with reference to the accompanying drawings.

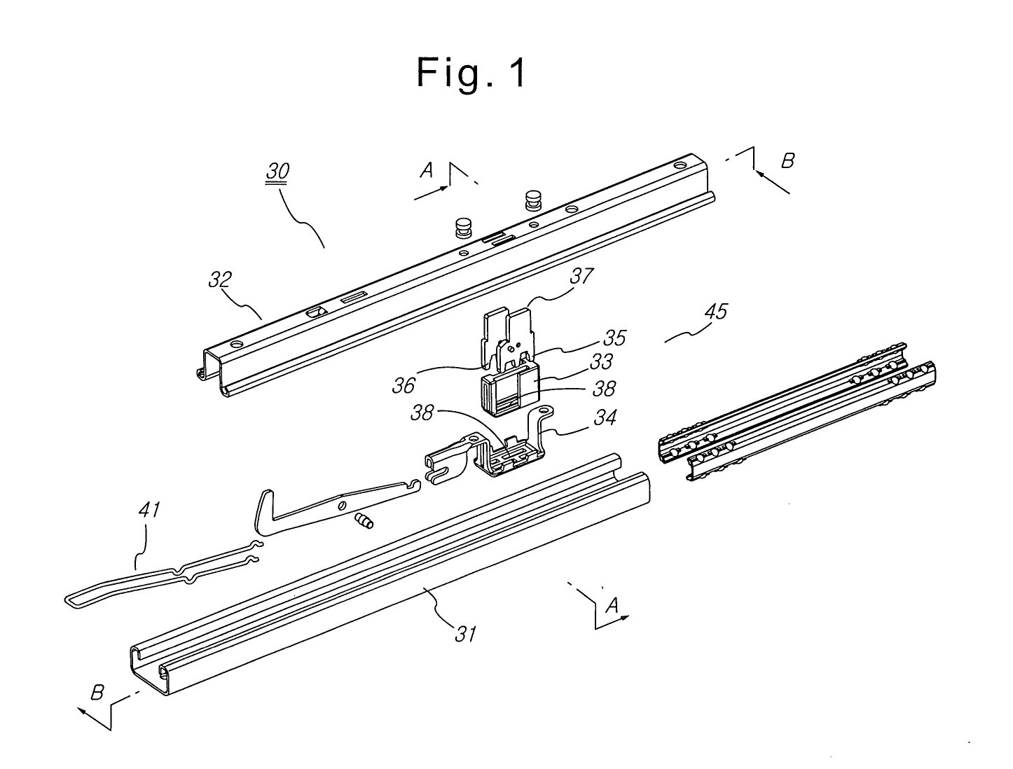

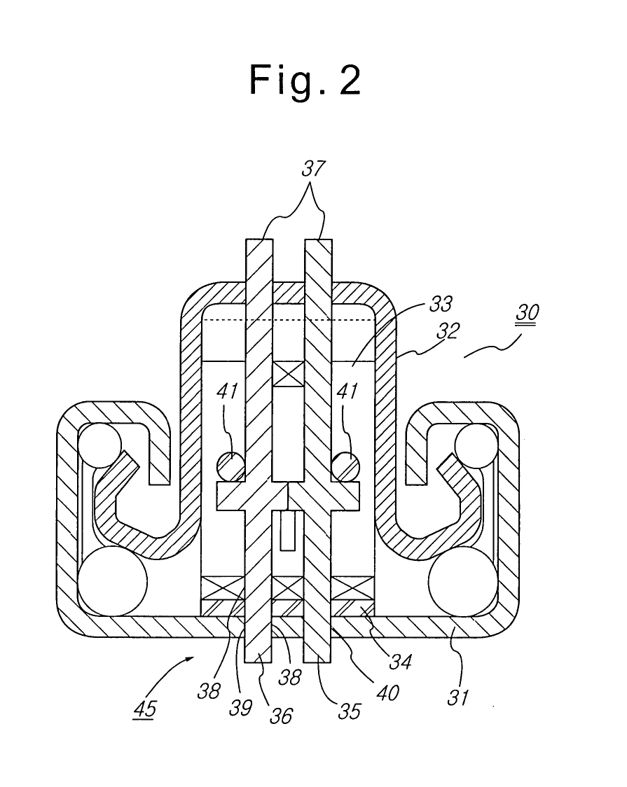

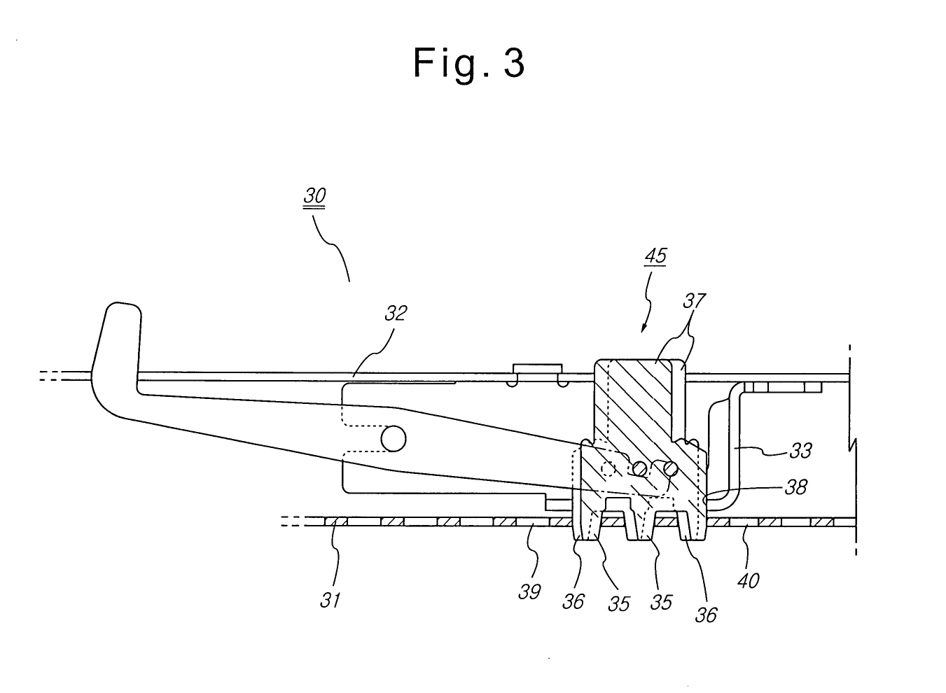

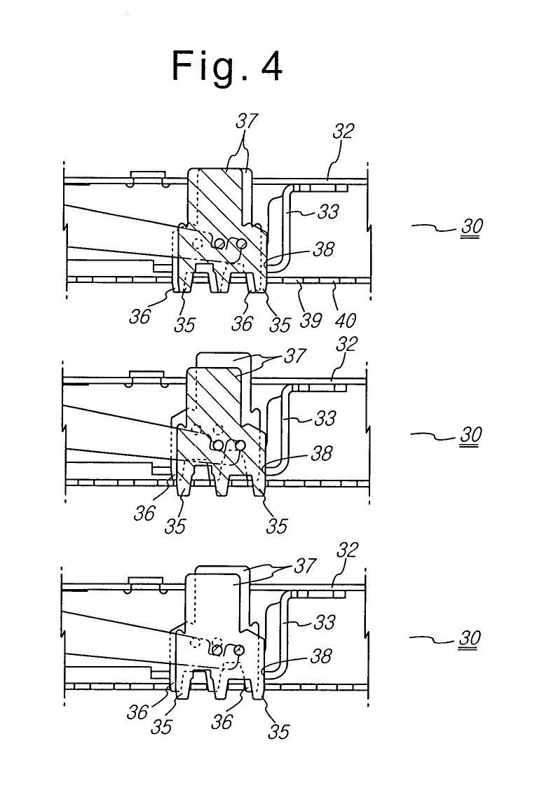

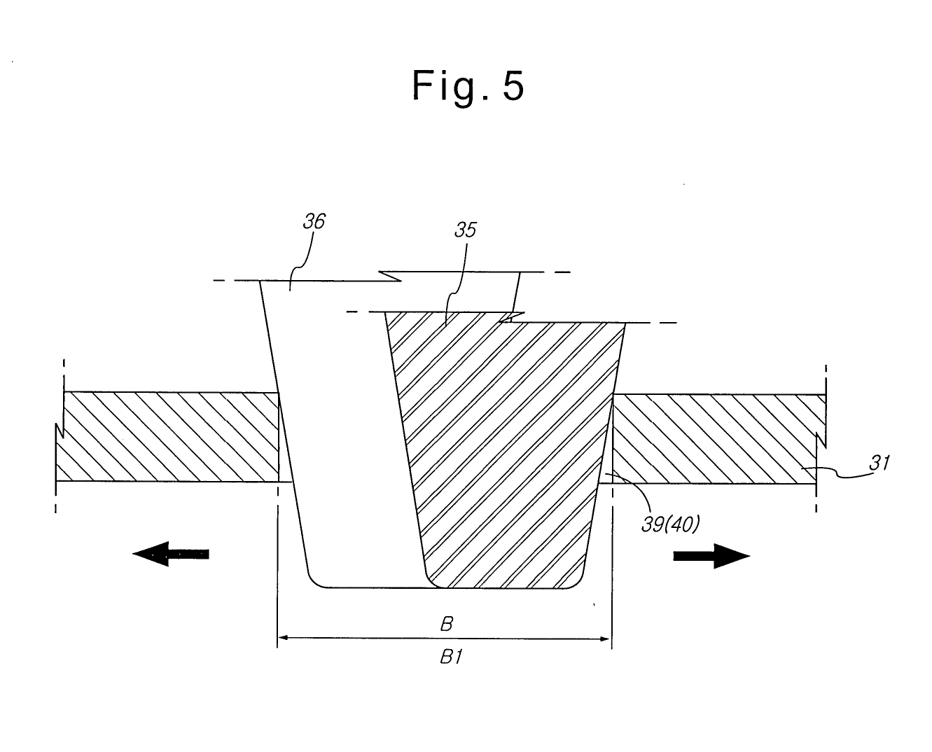

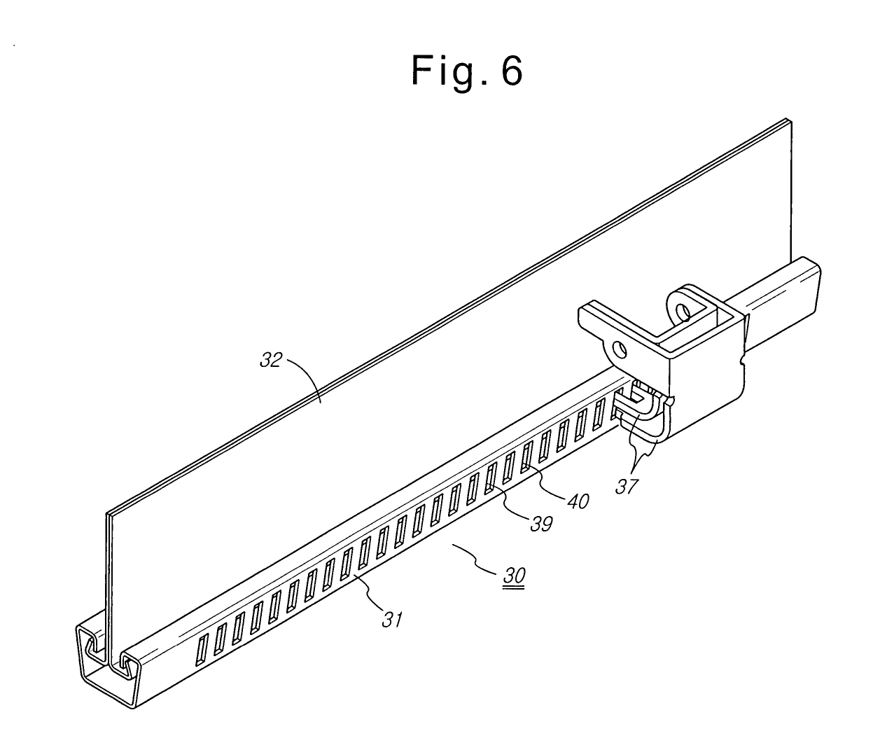

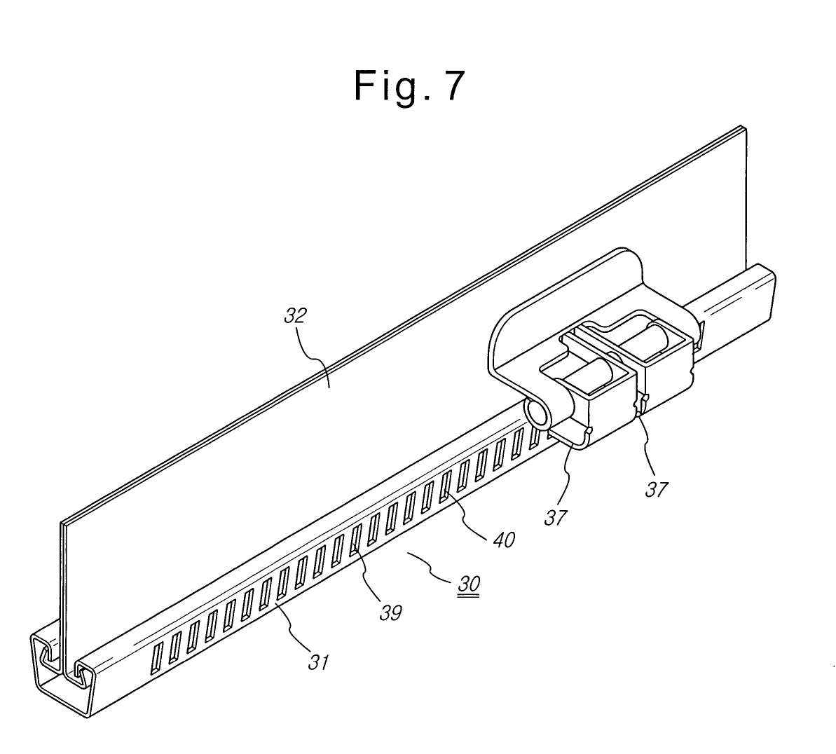

FIG. 1 is an exploded perspective view illustrating a seat rail for a vehicle with a locking device in accordance with one embodiment of the invention, FIG. 2 is a cross- sectional view taken along the line A-A of FIG. 1, and FIG. 3 is a cross-sectional view taken along the line B-B of FIG. 1. FIG. 4 shows the locking device of the seat rail for the vehicle in a locked state in accordance with the embodiment, and FIG. 5 is an enlarged cross-sectional view of the locking device in the locked state in accordance with the embodiment. FIG. 6 is a perspective view illustrating a seat rail for a vehicle with a locking device in accordance with another embodiment of the invention, and FIG. 7 is a perspective view illustrating a seat rail for a vehicle with a locking device in accordance with yet another embodiment of the invention.

Typically, a seat rail 30 for a vehicle includes a lower rail 31 fixed to a vehicle body, and an upper rail 32 coupled to the lower rail 31 and having a seat for a passenger fixed on the upper rail 32.

The seat rail 30 is provided with a locking guide 34, which is fixed to the bottom surface of the upper rail 32 and has a lock member bush 33 equipped therein, and with a pair of lock members 37 inside the locking guide 34 so as to be lifted and lowered inside the locking guide 34. Each of the lock members 37 is connected at an upper portion thereof to an operating lever, and has a plurality of locking protrusions 35 and 36 formed at a lower portion thereof.

The lock member bush 33 and the locking guide 34 are formed with entrance holes 38 so as to allow the lock member 48 and the locking protrusions 35 and 36 to freely enter and exit therethrough.

The lower rail 31 has locking grooves 39 and 40 uniformly spaced in the longitudinal direction on the bottom surface of the lower rail 31, such that the locking protrusions 35 and 36 can be engaged with the locking grooves 39 and 40, and the lock member 37 is provided with additional components, such as a lock spring 41 constantly pressing the lock member 10 so as to engage the locking protrusion 7 and 8 with the locking grooves 11 and 12, thereby completing a locking device 45 of the present invention.

The present invention is characterized in that the lock members 37 constituting the locking device 45 are enhanced in construction so that, even if the seat rail becomes worn or is deformed, the locking device maintains a sufficient locking force to prevent malfunctions such as misalignment between the left side and the right side of the seat rail 30, thereby ensuring vehicle seat safety.

For this purpose, the locking device 45 of the invention is provided with a pair of lock members 37, so that, even if the left side or the right side of the seat rail 30 is subject to deformation, all or some of the plurality of locking protrusions 35 and 36 provided to each of the lock members 37 are always coupled to associated locking grooves 39 and 40.

Preferably, the locking protrusions 35 and 36 are provided to the pair of the lock members 37, respectively, in a manner that one of the lock members 37 has the locking protrusions 35 and 36, which will be mainly located toward the front side of the seat rail 30 while the other has the locking protrusions 35 and 36, which will be mainly located toward the rear side of the seat rail 30, so that the locking protrusions 35 and 36 of the pair of the lock members 37 are alternately disposed at the same position on the seat rail 30 in the longitudinal direction, as shown in FIG. 5.

At this time, as shown in FIG. 5, a total width B from the front surface of the locking protrusion 36 of one of the lock members 37 to the rear surface of the protrusion 35 of the other lock member 37 alternately disposed at the same position on the seat rail 30 is the same as the length B1 of one locking groove 39 or 40.

The lock members of the present invention constructed as described above may be applied to a lateral type locking device, which is designed to be rotatably opened and closed in a lateral direction, as shown in FIGS. 6 and 7, as well as the vertical lift type locking device described in the drawings.

In this case, the locking protrusions 35 and 36 may be formed to the upper and lower lock members 37 stepped in the vertical direction, respectively, such that the locking protrusions 35 and 36 of the pair of the lock members 37 can be alternately disposed in the longitudinal direction at the same position on the seat rail 30.

In addition to this, in the case where the pair of lock members 37 are linearly disposed in the longitudinal direction, the locking protrusions 35 and 36 may be provided to the lock members 37 disposed in the longitudinal direction, such that one of the lock members 37 has the locking protrusions 35 and 36, which will be mainly located toward the front side of the seat rail 30 while the other has the locking protrusions 35 and 36, which will be mainly located toward the rear side of the seat rail 30, so that the locking protrusions 35 and 36 are alternately disposed in the longitudinal direction at the same position on the seat rail 30.

Further, without limitation to the construction described above, the pair of lock members 37 may be disposed far from each other or in different directions, under the condition that the locking protrusions may be provided to the pair of lock members 37, respectively, so as to have the same positioning of the protrusions on the seat rail 30 as that of the case where the pair of lock members 37 are disposed near to each other.

According to the present invention described above, position adjustment of the seat rail 30 allows the lock members 37 disposed between the lower rail 31 and the upper rail 32 to be lifted, so that the locking protrusions 35 and 36 of the locking members 37 are deviated from engagement with the locking groove 39 and 40 formed through the lower rail 31, thereby enabling the upper rail 32 having the seat mounted thereon to slide on the seat rail 30.

In this state, after repositioning the vehicle seat in the longitudinal direction, the lock members 37 are lowered by means of the lock spring 41, and returned to their original position in the locking guide 34 to allow the locking protrusions 35 and 36 of the lock member 37 to be engaged with the locking grooves 39 and 40, thereby allowing a repositioned state of the vehicle seat to be maintained.

When repositioning the vehicle seat according to the physical features of a passenger, as described above, misalignment between the left and right sides of the seat rail 30 occurs due to deformation of the seat rail 30, frequent use of the vehicle seat, external force, and the like.

However, even in such a state, since the locking device of the invention has the pair of lock members 37, which include the locking protrusions 35 and 36, such that the locking protrusions 35 and 36 are alternately disposed and thus deviated from each other in the longitudinal direction on the seat rail 30, thereby allowing a locked state to be easily maintained.

As a result, the pair of locking protrusions 35 and 36 may be completely engaged with associated locking grooves 39 and 40, respectively. Alternatively, one of the locking protrusions 35 and 36 may be completely engaged with an associated locking groove 39 or 40, while the other may not be engaged with another associated locking groove 39 or 40. Alternatively, both locking protrusions 35 and 36 may be partially engaged with the locking grooves 39 and 40. As such, the locking protrusions 35 and 36 are engaged with the locking grooves in various shapes in any position and state, thereby allowing the engagement between the locking protrusions and the locking grooves to be maintained.

Moreover, when the locking protrusions 35 and 36 are matched to the locking grooves 39 and 40, one of the locking protrusions 35 and 36 is located toward the front of the seat rail 30, while the other is located toward the rear of the seat rail 30, so that the locking protrusions are engaged with the locking grooves without clearance therebetween, thereby allowing firm engagement therebetween to be maintained.

As such, even when clearance or deformation is created between related components of the lock members 37 when using the lock members 37, since lock members 37 has the locking protrusions 35 and 36, designed to be engaged with the locking grooves 39 and 40 in any states with intimate contact between the locking protrusions 35 and 36 and the locking grooves 39 and 40, the locking device can provide an optimized locked state.

As apparent from the above description, the present invention provides advantageous effects in that the problems, such as the clearance or engagement error caused by a conventional single lock member, are overcome, and in that the locking device can actively cope with deformation or twisting of left and right sides of the seat rail, thereby ensuring safety of the seat rail while enhancing comfort of vehicle seat.

It should be understood that the embodiments and the accompanying drawings have been described for illustrative purposes and the present invention is limited by the following claims. Further, those skilled in the art will appreciate that various modifications, additions and substitutions are allowed without departing from the scope and spirit of the invention as set forth in the accompanying claims.

1. A locking device of a seat rail for a vehicle, comprising:
a lower rail fixed to a vehicle body;
an upper rail coupled to the lower rail 31 and having a seat for a passenger fixed on the upper rail;
a locking guide fixed to a bottom surface of the upper rail;
one or more lock members provided inside the locking guide, in a manner that each of the lock members is connected at an upper portion to an operating lever and formed at a lower portion with a plurality of locking protrusions, so as to be lifted and lowered inside the locking guide;
a plurality of locking grooves formed through a bottom surface of the lower rail so as to be engaged with the locking protrusions; and
a lock spring provided inside the locking guide to constantly press the lock members such that the locking protrusions are engaged with the locking grooves of the lower rail,
wherein the locking device includes a pair of lock members such that, even when deformation occurs at left or right sides of the seat rail, all or some of the plurality of locking protrusions of the pair of the lock members can be maintained in an engaged stated with the locking grooves, and
wherein the locking protrusions are alternately disposed on the seat rail by providing the locking protrusions to the pair of the lock members in different directions on the seat rail in order to easily cope with the deformation of the seat rail.

2. The device as set forth in claim 1, wherein a total width from a front surface of the locking protrusion of one of the pair of the lock members to the rear surface of the protrusion of the other of the pair of the lock members is the same as a length of one locking groove of the lower rail, the protrusions of the pair of the lock members being alternately disposed at the same position on the seat rail.

3. The device as set forth in claim 1, wherein the pair of the lock members are installed to the seat rail such that the lock members can be rotatably opened or closed to the seat rail in a lateral direction.

4. The device as set forth in claim 1, wherein the pair of the lock members are disposed near to each other.

5. The device as set forth in claim 1, wherein the pair of lock members are disposed far from each other or in different directions, so as to have the same positioning of the protrusions on the seat rail as that of the case where the pair of lock members are disposed near to each other.

6. The device as set forth in claim 3, wherein the pair of the lock members are disposed near to each other.

7. The device as set forth in claim 3, wherein the pair of lock members are disposed far from each other or in different directions, so as to have the same positioning of the protrusions on the seat rail as that of the case where the pair of lock members are disposed near to each other.

8. The device as set forth in claim 3, wherein the pair of lock members are disposed in a vertical direction to have step-shaped upper and lower lock members, and the locking protrusions are formed to the upper and lower lock members, respectively, such that the locking protrusions can be alternately disposed in the longitudinal direction at the same position on the seat rail.

9. The device as set forth in claim 3, wherein the pair of lock members are linearly disposed in the longitudinal direction on the seat rail, and the locking protrusions are formed to the lock members, respectively, such that the locking protrusions are alternately disposed in the longitudinal direction at the same position on the seat rail.
